(19) United States
(12) Patent Application Publication
(10) Pub. No.: US 2010/0031569 A1
(43) Pub. Date: Feb. 11, 2010

(54) USE OF HERBACEOUS AQUATIC PLANTS AS SOILLESS CULTURE MEDIUM AND MEDIUM SO FORMED

(75) Inventors: Herve Floury, Plourivo (FR); Herve Le Deit, Lannion Servel (FR); Bruno Jacob, Trebeurden (FR); Jean-Francois Sassi, Ploubazlanec (FR)

Correspondence Address: Pepper Hamilton LLP, 400 Berwyn Park, 899 Cassatt Road, Berwyn, PA, 19312-1183, US

(73) Assignee: ALGIEPLUS, La Teste De Buch (FR)

(21) Appl. No.: 12/516,897

(22) PCT Filed: Nov. 27, 2007
(86) PCT No.: PCT/EP2007/062904

§ 371 Date: May 29, 2009

(30) Foreign Application Priority Data
Nov. 30, 2006 (FR) 06/10471

(51) Int. Cl. A01G 31/00

(52) U.S. Cl. 47/59 S

(57) ABSTRACT

The present invention relates to the use of dry and compacted aquatic grasses containing zosteric acid and/or zosterin, as a support for soil-less cultivation. It also relates to a support for cultivation consisting at least in part of such aquatic grasses.

The present invention relates to the use of dry, compacted herbaceous aquatic plants containing zosteric acid and/or zosterin as a medium for soilless culture.

It also refers to a soilless culture medium formed at least in part of said herbaceous aquatic plants.

Soilless cultivation of fruit and vegetables is also called hydroponic culture.

One very widespread example of a soilless culture medium consists of rock wool which is compressed to form compact slabs used for rooting of the plants to be cultivated.

A nutrient solution is added to the rock wool slabs. It forms the sole “feed” source of the plant.

Said means have been developed since they are easy to implement and allow numerous plants to be cultivated protected from the most frequent diseases encountered with “traditional” cultures in which these plants are directly planted in the ground.

However, the very nature of this medium suffers from a non-friendly ecological image, at a time when we are experiencing a period in which numerous consumers are demanding healthy eating and culture methods that are as authentic as possible.

Other products have been proposed for soilless culture.

These are mainly coconut fibres or coir.

The use of dried, compacted herbaceous aquatic plants has also been put forward.

Such herbaceous plants are grasses with inflorescences which live and develop in water. They are called “aquatic grasses” since most types thereof have elongate, ribbon-like leaves.

In the dry state, such grasses are notably used for heat insulation (as insulation panels) phonic insulation, as a substitute for straw for roofing houses, as padding and packing material for the transport of goods.

Posidonia is a genus already known for its use in soilless culture.

These natural products give very good results in terms of plant development.

However, they have a certain number of drawbacks as detailed below.

First, they require a regular and abundant supply of water and nutrient solution owing to the high evaporation and low liquid retaining capacity of this mass of dried grass.

Additionally, this matter most often requires disinfection to reduce the risk of transmission of diseases to the cultivated plants as much as possible.

The purpose of the invention is to find a solution to these problems.

Thus, one first objective is to propose a soilless culture medium of dried aquatic grass type, which guarantees proper growth of the plants to be cultivated whilst reducing the risk of disease transmission through contact between this medium and the root system.

Another objective is to propose a soilless culture medium which has a high liquid-retaining capacity thus allowing the frequency of watering of this medium to be reduced.

The present invention therefore relates to the use dried, compacted aquatic grasses containing zosteric acid and/or zosterin as soilless culture medium.

The functions and advantages of zosteric acid and zosterin will be explained below.

By the term “containing” is meant the presence of both endogenous and exogenous zosteric acid and/or zosterin.

In other words, these products may be constituents of said herbaceous plants as well as additives impregnating the same.

According to other advantageous but non-limiting characteristics:

zosteric acid and/or zosterin is an endogenous product (are exogenous products), i.e. a constituent or constituents of said grasses;
said grasses are Zosteraceae and preferably Zostera;
zosteric acid and/or zosterin is an exogenous product (are exogenous products), i.e. one or more additives impregnating said grasses.

The invention also relates to a soilless culture medium characterized by the fact that it consists, at least in part, of dry, compacted aquatic grass containing zosteric acid and/or zosterin.

Further, according to other advantageous, non-limiting characteristics:
zosteric acid and/or zosterin is an endogenous product (are exogenous products), i.e. a constituent or constituents of said grasses;
said grasses are Zosteraceae and preferably Zostera;
zosteric acid and/or zosterin is an exogenous product (are exogenous products), i.e. one or more additive(s) impregnating said grasses;
the medium only consists in part of dry, compacted aquatic grass containing zosteric acid and/or zosterin, and it also comprises fibres whether or not of marine origin, natural or synthetic, or a mixture of these fibres;
it is impregnated with a nutrient solution and/or nutrient salt and/or at least one natural or synthetic active ingredient for plant health.

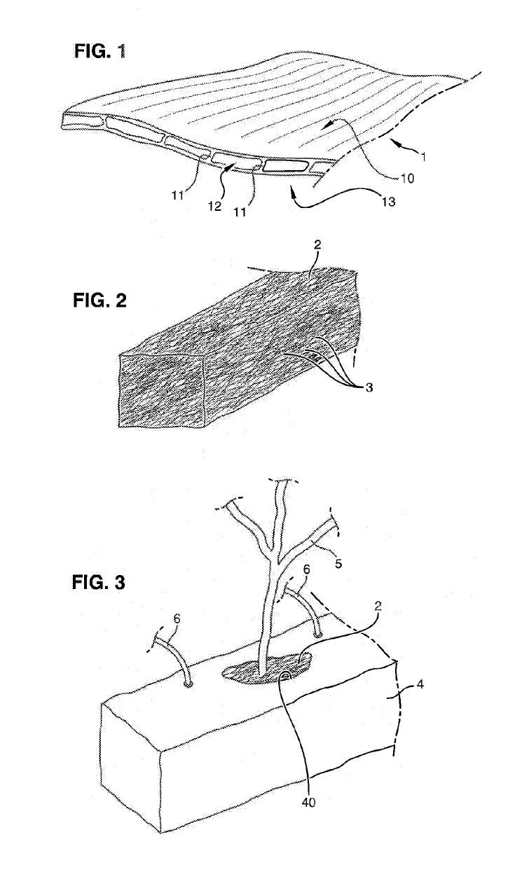

Other characteristics and advantages of the present invention will become apparent upon reading the following detailed description. It is given with reference to the appended drawings in which:
FIG. 1 is a simplified cross-sectional view of a Zostera fibre, as seen under an electronic microscope;
FIG. 2 is a perspective view of a slab forming a soilless culture medium, consisting at least in part of dry, compacted aquatic grass containing zosteric acid and/or zosterin;
FIG. 3 is a schematic showing how soilless culture is conducted using a slab such as the one in FIG. 2.

The present invention is essentially based on the use of particular characteristics of natural chemical components (which can optionally be produced synthetically) namely zosterin and zosteric acid.

These compounds are naturally present in Zosteraceae which are marine phanerogams belonging to a family distinct from Posidonaceae.

There are two genii of Zosteraceae: Zostera and Phyllospadix.

In Europe, only two species of Zostera are found, namely zostera marina and zostera noltii or nana.

As mentioned above, the invention particularly relates to the use of dry, compacted aquatic grass containing zosteric acid and/or zosterin as a soilless culture medium.

In a particularly preferred manner, said grass is a Zosteraceae and preferably a Zostera.

In this case, use is made both of the physical and of the chemical characteristics of Zostera.

As mentioned at the beginning of the description, FIG. 1 is a cross-sectional view of a Zostera fibre as seen under an electronic microscope.

This fibre 1 has two large sides 10 and 13 which are separated by a series of intermediate partitions which, in pairs, delimit a series of cavities or alveoli 12.

Zostera fibres therefore have an inner pore space, the walls of the alveoli consisting of cellulose and a particular pectin, namely zosterin.

As will be seen in more detail below, this pore structure is used under the present invention to increase the water-retaining potential of the soilless culture medium.

Zostera also contain zosteric acid or para-sulfoxy cinnamic acid. It is an “anti-fouling” molecule which, in a marine medium, is active against the adhering of bacteria of algae or shellfish onto the leaves of the plant.

They also contain rosmarinic acid, flavonoids and phenol compounds which are all antioxidants with anti-free radical properties.

Advantage is taken of all these properties and characteristics when these herbaceous plants are used as soilless culture media.

For this purpose, the grass is harvested and dried, either naturally or in an oven, until adequate dryness is obtained.

After this operation the raw material, with an initial density value close to 1, has this density reduced to reach 0.2-0.3.

The dried grass is then compacted, for example by tight packing or by compacting under a standard press.

A slab is thus obtained such as schematically shown in FIG. 2 under reference 2. It consists of an amalgam of Zostera fibres 3 intertwined with one another to form a compact block having certain mechanical cohesion.

In the example shown here, the block is a substantially parallelepiped block, e.g. of 60 centimetres in length, 20 to 25 centimetres wide and 10 centimetres high.

Under embodiments not illustrated, the blocks could be cubic or could be in the form of small pebbles able to receive a young plant to be developed.

FIG. 3 illustrates the slab of FIG. 2 such as used as soilless culture medium to cultivate a tomato plant 5, for example.

This block is packed in a plastic wrap 4 as is known in the state of the art. This wrap has a dual function. First, it isolates the block from the outside medium, which contributes towards reducing the risk of transmission of diseases to the cultivated plants.

Second, it forms a sealed barrier, considerably limiting the evaporation of watering liquid.

Evidently, the wrap 4 is pierced with an opening 40 for planting of the plant 5.

Reference 6 is given to two small pipes, one end of which opens into the block 2 passing through the wrap 4.

The other end of these pipes is connected to a watering installation, for example for trickle irrigation.

This installation delivers a water-based nutrient solution.

Optionally, the block fibres are previously impregnated with a nutrient solution and/or nutrient salt and/or at least one natural or synthetic active ingredient for plant health.

Compared with plants cultivated on media consisting of coconut fibres, rock wool or other herbaceous aquatic plants, it is observed that in this case, the frequency of watering can be notably reduced.

This can be accounted for by the fact that the hollow, alveolar structure of the fibres retains the liquid for a much longer length of time. The liquid-retaining potential is therefore improved, which slows the drying-out rate of the block. Watering frequency can hence be lowered.

The good “health” of the plant, here a tomato plant, can be seen through its good harvesting yield. Another visual sign is the development of the root system.

On observing the roots of plants cultivated on a medium according to the invention, it is found that these roots are particularly well developed and evenly distributed around the entire volume of the block.

These roots are healthy, i.e. they do not carry the stigma characteristic of some diseases. This can be explained by the antifungal and bactericidal properties of zosteric acid.

Additionally, these Zostera fibres are fully biodegradable, but have the quality of degrading very slowly, thereby extending the lifetime of the medium.

Evidently, according to the invention, it is possible to produce soilless culture media consisting partly of Zostera, the remaining part consisting of natural or synthetic fibres either alone or in a mixture.

Evidently, by lowering the Zostera content in the medium, less advantage is drawn from the qualities and characteristics described above.

Finally, in one alternative embodiment, use can be made of other herbaceous aquatic plants previously impregnated with zosteric acid and/or zosterin.

1-10. (canceled)

11. Soilless culture medium comprising dry, compacted, aquatic grass, wherein the aquatic grass contains zosteric acid and/or zosterin.

12. The soilless culture medium according to claim 11 wherein the aquatic grass contains endogenous zosteric acid and/or zosterin.

13. The soilless culture medium according to claim 12 further comprising additional exogenous zosteric acid and/or zosterin.

14. The soilless culture medium according to claim 11 wherein the aquatic grass contains exogenous zosteric acid and/or zosterin.

15. The soilless culture medium according to claim 12 wherein the aquatic grass is Zosteraceae.

16. The soilless culture medium according to claim 15 wherein the Zosteraceae is Zostera.

17. The soilless culture medium according to claim 11 further comprising a natural fibre or a synthetic fibre, or a mixture thereof.

18. The soilless culture medium according to claim 11 further comprising a nutrient solution and/or nutrient salt and/or at least one natural or synthetic active ingredient for plant health.

19. A block comprising soilless culture medium, wherein the soilless culture medium comprises dry, compacted, aquatic grass, wherein the aquatic grass contains zosteric acid and/or zosterin.

20. The block according to claim 19 wherein the aquatic grass contains endogenous zosteric acid and/or zosterin.

21. The block according to claim 19 wherein the aquatic grass contains exogenous zosteric acid and/or zosterin.

22. The block according to claim 19 packed in a plastic wrap.

23. The block according to claim 22 wherein the plastic wrap comprises an opening for planting of a plant.

24. The block according to claim 23 further comprising two pipes, wherein each pipes passes through the plastic wrap, and wherein one end of each pipe opens into the block.

25. The block according to claim 20 wherein the soilless culture medium further comprises additional exogenous zosteric acid and/or zosterin.

26. The block according to claim 20 wherein the aquatic grass is Zosteraceae.

27. The block according to claim 26 wherein the Zosteraceae is Zostera.

28. The block according to claim 19 wherein the soilless culture medium further comprises a natural fibre or a synthetic fibre, or a mixture thereof.

29. The block according to claim 19 wherein the soilless culture medium further comprises a nutrient solution and/or nutrient salt and/or at least one natural or synthetic active ingredient for plant health.

30. A method of preparing a block comprising soilless culture medium comprising:
a) compacting dried aquatic grass, wherein the aquatic grass contains endogenous zosteric acid and/or zosterin to obtain a block; and
b) packing the block in a plastic wrap, wherein the plastic wrap comprises an opening for planting of a plant.

31. A method of cultivating a plant comprising planting the plant in the soilless culture medium according to claim 11.
